(19) United States
(12) Patent Application Publication
(10) Pub. No.: US 2022/0391129 A1
(43) Pub. Date: Dec. 8, 2022

(54) STORAGE DEVICE, HOST DEVICE, AND METHOD OF OPERATING THE SAME

(71) Applicant: SK hynix Inc., Icheon (KR)

(72) Inventor: Jong Min LEE, Icheon (KR)

(21) Appl. No.: 17/543,615

(22) Filed: Dec. 6, 2021

(30) Foreign Application Priority Data
Jun. 7, 2021 (KR) 10-2021-0073774

(51) Int. Cl. G06F 3/06

(52) U.S. Cl. CPC G06F 3/0655; G06F 3/0604; G06F 3/0679

(57) ABSTRACT

A host device determines to delete data corresponding to a selected logical block address, transmits a trim request corresponding to the selected logical block address to a storage device, and re-transmitting the trim request to the storage device based on whether a re-transmission requirement of the trim request has been satisfied. The storage device receives the trim request from the host device, determines whether the trim request is a first trim request, and performs a trim operation corresponding to the received trim request based on a result of the determination. The memory device may store one or more trim requests in a buffer memory and perform the trim operation according to the stored trim requests.

### CROSS-REFERENCE TO RELATED APPLICATION

The present application claims priority under 35 U.S.C. § 119(a) to Korean patent application number 10-2021-0073774 filed on Jun. 7, 2021, which is incorporated by reference in its entirety.

### BACKGROUND

### 1. Field of Invention

The present disclosure relates to an electronic device, and more particularly, to a storage device, a host device, and methods of operating the same.

### 2. Description of Related Art

A semiconductor memory device may be formed in a two-dimensional structure in which strings of memory cells are horizontally arranged on a semiconductor substrate, or in a three-dimensional structure in which the strings of memory cells are vertically stacked on the semiconductor substrate. A three-dimensional semiconductor memory device is a memory device designed to surpass a limit on a degree of integration of a two-dimensional semiconductor memory device, and may include a plurality of memory cells that are vertically stacked on a semiconductor substrate. Meanwhile, a controller may control an operation of the semiconductor memory device according to a request from a host device.

### SUMMARY

An embodiment of the present disclosure provides a storage device, a host device, and a method of operating the same capable of efficiently performing a trim operation.

According to an embodiment of the present disclosure, a method of operating a host device include selecting logical block address, the logical block address corresponding to data to be deleted, transmitting a trim request corresponding to the selected logical block address to a storage device, determining whether a re-transmission requirement of the trim request is satisfied, and re-transmitting the trim request to the storage device in response to determining that the re-transmission requirement of the first trim request is satisfied.

According to another embodiment of the present disclosure, a method of operating a host device includes selecting a logical block address corresponding to data to be deleted, transmitting a first trim request corresponding to the selected logical block address to the storage device, determining whether a re-transmission requirement of the first trim request is satisfied, and transmitting a second trim request corresponding to the selected logical block address to the storage device in response to determining that the re-transmission requirement of the trim request is satisfied.

According to still another embodiment of the present disclosure, a method of operating a storage device includes receiving a trim request from a host device, determining whether the trim request is a first trim request, and performing a trim operation corresponding to the received trim request according to a result of the determination.

The present technology may provide a storage device, a host device, and a method of operating the same capable of efficiently performing a trim operation.

### BRIEF DESCRIPTION OF THE DRAWINGS

FIG. 1 is a block diagram illustrating a storage device and a host device according to an embodiment of the present disclosure.

FIG. 2 is a block diagram illustrating a semiconductor memory device according to FIG. 1.

FIG. 3 illustrates an embodiment of a memory cell array of FIG. 2.

FIG. 4 is a circuit diagram illustrating any one memory block BLKa among memory blocks BLK1 to BLKz of FIG. 3.

FIG. 5 is a circuit diagram illustrating an embodiment of any one memory block BLKb among the memory blocks BLK1 to BLKz included in the memory cell array 110 of FIG. 2.

FIG. 6 is a block diagram illustrating a trim operation controlled by a host device according to an embodiment of the present disclosure.

FIGS. 7A and 7B are diagrams illustrating an update of map data according to the trim operation.

FIG. 8 is a flowchart illustrating a process of operating a storage device according to an embodiment of the present disclosure.

FIG. 9 is a flowchart illustrating a process of operating a storage device according to another embodiment of the present disclosure.

FIG. 10 is a block diagram illustrating a trim operation performed by the operation process of FIG. 9.

FIG. 11 is a flowchart illustrating a process of operating a host device according to an embodiment of the present disclosure.

FIG. 12 is a block diagram illustrating a trim operation performed by the operation process of FIG. 11.

FIG. 13 is a flowchart illustrating a process of operating a storage device according to still another embodiment of the present disclosure.

FIG. 14 is a flowchart illustrating a process of operating a host device according to another embodiment of the present disclosure.

FIG. 15 is a flowchart illustrating a process of operating a storage device according to still another embodiment of the present disclosure.

FIG. 16 is a block diagram illustrating a storage device including a semiconductor memory device and a controller.

FIG. 17 is a block diagram illustrating an application example of the storage device of FIG. 16.

FIG. 18 is a block diagram illustrating a computing system including the storage device described with reference to FIG. 17.

### DETAILED DESCRIPTION

The advantages and features of the present disclosure, and a method of accomplishing the advantages and features will be described through embodiments that are described in detail below together with the accompanying drawings. However, the present disclosure is not limited to the embodiments described herein but may be embodied in other forms. The present embodiments are provided to describe the technical spirit of the present disclosure in detail to those skilled in the art to which the present disclosure pertains so that those skilled in the art may easily implement the technical spirit of the present disclosure.

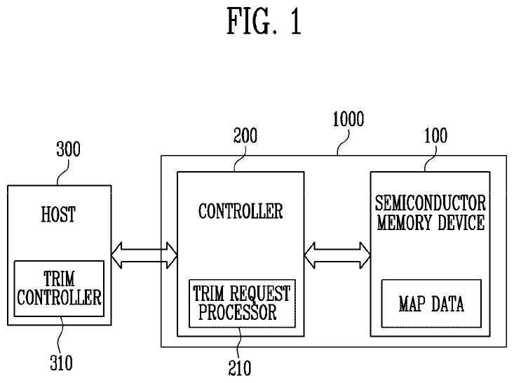

FIG. 1 is a block diagram illustrating a storage device 1000 and a host device 300 according to an embodiment of the present disclosure.

The storage device 1000 includes a semiconductor memory device 100 and a controller 200. The storage device 1000 communicates with the host device 300. The controller 200 controls an overall operation of the semiconductor memory device 100. The controller 200 may control an operation of the semiconductor memory device 100 based on an operation request received from the host device 300.

The semiconductor memory device 100 operates under the control of the controller 200. The semiconductor memory device 100 includes a memory cell array having a plurality of memory blocks. In an embodiment, the semiconductor memory device 100 may be a flash memory device.

The controller 200 may receive a write request, a read request, a trim request, or the like from the host device 300, and control the semiconductor memory device 100 based on the received requests. More specifically, the controller 200 may generate commands for controlling the operation of the semiconductor memory device 100 and transmit the commands to the semiconductor memory device 100.

The semiconductor memory device 100 is configured to receive a command and an address from the controller 200 and to access an area selected by the address of the memory cell array. That is, the semiconductor memory device 100 performs an internal operation corresponding to the command on the area selected by the address.

For example, the semiconductor memory device 100 may perform a program operation, a read operation, and an erase operation. During the program operation, the semiconductor memory device 100 may program data in the area selected by the address. During the read operation, the semiconductor memory device 100 may read data from the area selected by the address. During the erase operation, the semiconductor memory device 100 may erase data stored in the area selected by the address.

The host device 300 includes a trim controller 310. The trim controller 310 may generate a trim request in order to control the storage device 1000 to perform a trim operation on data stored in the storage device 1000. The host device 300 generates the trim request for trimming data to be deleted among data stored in the storage device 1000, and transmits the generated trim request to the controller 200 of the storage device 1000. The controller 200 includes a trim request processor 210 for processing the trim request received from the host device 300. The trim request processor 210 may be implemented using, for example, firmware executing on a microprocessor or microcontroller included in the controller 200. The trim request processor 210 of the controller 200 invalidates data corresponding to the received trim request, in response to the trim request received from the host device 300. That is, the storage device 1000 may invalidate the data corresponding to the trim request received from the host device 300. The invalidated data may later be removed from the storage device 1000 by a garbage collection (GC) operation.

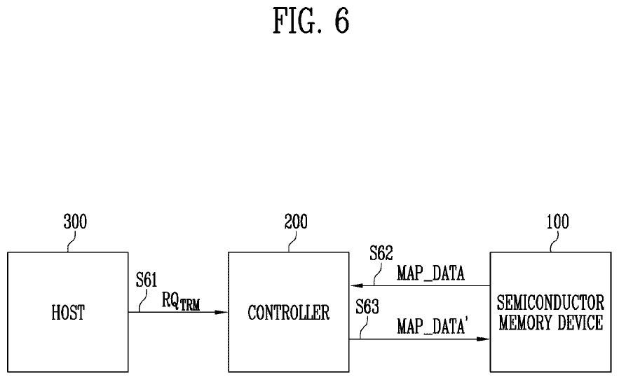

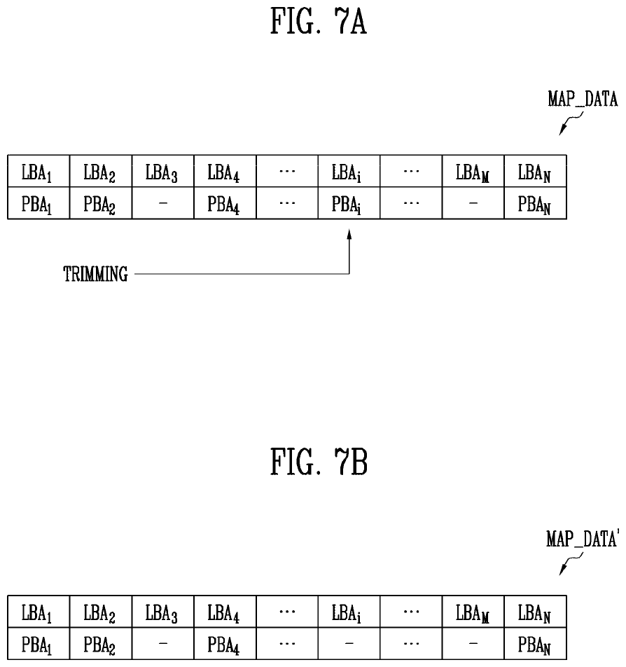

More specifically, the trim request processor 210 may update map data to invalidate the data corresponding to the trim request. The map data may be stored in the semiconductor memory device 100. The trim request processor 210 may control the semiconductor memory device 100 to read the map data stored in the semiconductor memory device 100. To this end, the trim request processor 210 may generate a read command for reading the map data, and transmit the generated read command to the semiconductor memory device 100. The semiconductor memory device 100 may read the map data in response to the received read command, and may transmit the read map data to the controller 200. The trim request processor 210 may update the received map data, based on the trim request. The trim request processor 210 may transmit the updated map data to the semiconductor memory device 100. In addition, the trim request processor 210 may transmit a program command for programming the updated map data to the semiconductor memory device 100. The semiconductor memory device may program the updated map data, in response to the program command. A process in which the storage device 1000 updates the map data in response to the trim request is described later with reference to FIGS. 6, 7A, and 7B.

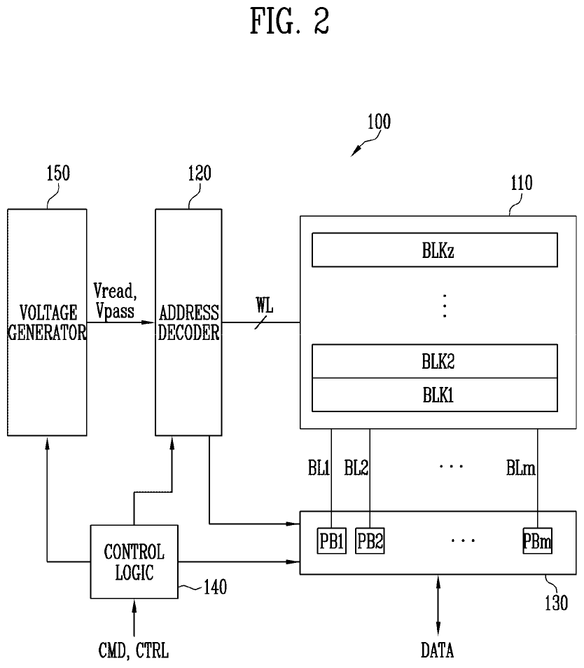

FIG. 2 is a block diagram illustrating the semiconductor memory device 100 according to FIG. 1.

The semiconductor memory device 100 includes a memory cell array 110, an address decoder 120, a read and write circuit 130, control logic 140, and a voltage generator 150.

The memory cell array 110 includes a plurality of memory blocks BLK1 to BLKz. The plurality of memory blocks BLK1 to BLKz are connected to the address decoder 120 through word lines WL. The plurality of memory blocks BLK1 to BLKz are connected to the read and write circuit 130 through bit lines BL1 to BLm. Each of the plurality of memory blocks BLK1 to BLKz includes a plurality of memory cells. In an embodiment, the plurality of memory cells are non-volatile memory cells, and may be configured of non-volatile memory cells having a vertical channel structure. In an embodiment, the memory cell array 110 may be configured as a memory cell array having a two-dimensional structure. In another embodiment, the memory cell array 110 may be configured as a memory cell array of a three-dimensional structure. Each of the plurality of memory cells included in the memory cell array may store at least one bit of data. In an embodiment, each of the plurality of memory cells included in the memory cell array 110 may be a single-level cell (SLC) storing one bit of data. In another embodiment, each of the plurality of memory cells included in the memory cell array 110 may be a multi-level cell (MLC) storing two bits of data. In still another embodiment, each of the plurality of memory cells included in the memory cell array 110 may be a triple-level cell (TLC) storing three bits of data. In still another embodiment, each of the plurality of memory cells included in the memory cell array 110 may be a quad-level cell (QLC) storing four bits of data. According to an embodiment, the memory cell array 110 may include a plurality of memory cells each storing five or more bits of data.

The address decoder 120, the read and write circuit 130, the control logic 140, and the voltage generator 150 operate as a peripheral circuit driving the memory cell array 110. The address decoder 120 is connected to the memory cell array 110 through the word lines WL. The address decoder 120 is configured to operate in response to control of the control logic 140. The address decoder 120 receives an address through an input/output buffer (not shown) inside the semiconductor memory device 100.

The address decoder 120 is configured to decode a block address among received addresses. The address decoder 120 selects at least one memory block according to the decoded block address. In addition, the address decoder 120 applies a read voltage Vread generated in the voltage generator 150 to a selected word line of the selected memory block at a time of a read voltage application operation during a read operation, and applies a pass voltage Vpass to the remaining unselected word lines. In addition, during a program verify operation, the address decoder 120 applies a verify voltage generated in the voltage generator 150 to the selected word line of the selected memory block, and applies the pass voltage Vpass to the remaining unselected word lines.

The address decoder 120 is configured to decode a column address of the received addresses. The address decoder 120 transmits the decoded column address to the read and write circuit 130.

A read operation and a program operation of the semiconductor memory device 100 are performed in units of one page. Addresses received at a time of a request of the read operation and the program operation include a block address, a row address, and a column address. The address decoder 120 selects one memory block and one word line according to the block address and the row address. The column address is decoded by the address decoder 120 and is provided to the read and write circuit 130.

The address decoder 120 may include a block decoder, a row decoder, a column decoder, an address buffer, and the like.

The read and write circuit 130 includes a plurality of page buffers PB1 to PBm. The read and write circuit 130 may operate as a “read circuit” during a read operation of the memory cell array 110 and may operate as a “write circuit” during a write operation of the memory cell array 110. The plurality of page buffers PB1 to PBm are connected to the memory cell array 110 through the bit lines BL1 to BLm. During the read operation and the program verify operation, in order to sense a threshold voltage of the memory cells, the plurality of page buffers PB1 to PBm senses a change of an amount of a current flowing according to a programmed state of a corresponding memory cell through a sensing node while continuously supplying a sensing current to the bit lines connected to the memory cells, and latches the sensed change as sensing data. The read and write circuit 130 operates in response to page buffer control signals output from the control logic 140.

During the read operation, the read and write circuit 130 senses data of the memory cell, temporarily stores read data, and outputs data DATA to the input/output buffer (not shown) of the semiconductor memory device 100. In an example embodiment, the read and write circuit 130 may include a column selection circuit, and the like, in addition to the page buffers (or page registers).

The control logic 140 is connected to the address decoder 120, the read and write circuit 130, and the voltage generator 150. The control logic 140 receives a command CMD and a control signal CTRL through the input/output buffer (not shown) of the semiconductor memory device 100. The control logic 140 is configured to control overall operations of the semiconductor memory device 100 in response to the control signal CTRL. In addition, the control logic 140 outputs a control signal for adjusting a sensing node pre-charge potential level of the plurality of page buffers PB1 to PBm. The control logic 140 may control the read and write circuit 130 to perform the read operation of the memory cell array 110.

The voltage generator 150 generates the read voltage Vread and the pass voltage Vpass during the read operation in response to the control signal output from the control logic 140. In order to generate a plurality of voltages having various voltage levels, the voltage generator 150 may include a plurality of pumping capacitors that receive an internal power voltage, and generate the plurality of voltages by selectively activating the plurality of pumping capacitors in response to the control of the control logic 140.

The address decoder 120, the read and write circuit 130, and the voltage generator 150 may function as a peripheral circuit that performs a read operation, a write operation, and an erase operation on the memory cell array 110. The peripheral circuit performs the read operation, the write operation, and the erase operation on the memory cell array 110 under the control of the control logic 140.

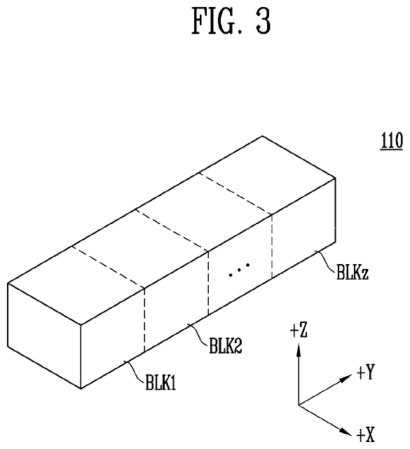

FIG. 3 is a diagram illustrating an embodiment of the memory cell array 110 of FIG. 2.

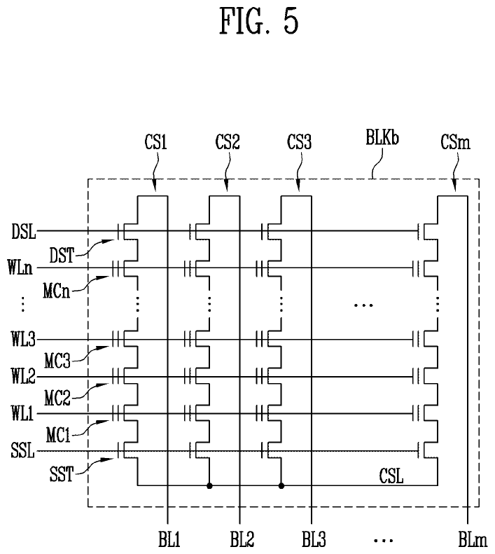

The memory cell array 110 includes a plurality of memory blocks BLK1 to BLKz. Each memory block may have a three-dimensional structure. Each memory block includes a plurality of memory cells stacked on a substrate. Such plurality of memory cells are arranged along a +X direction, a +Y direction, and a +Z direction. A structure of each memory block is described in more detail with reference to FIG. 5.

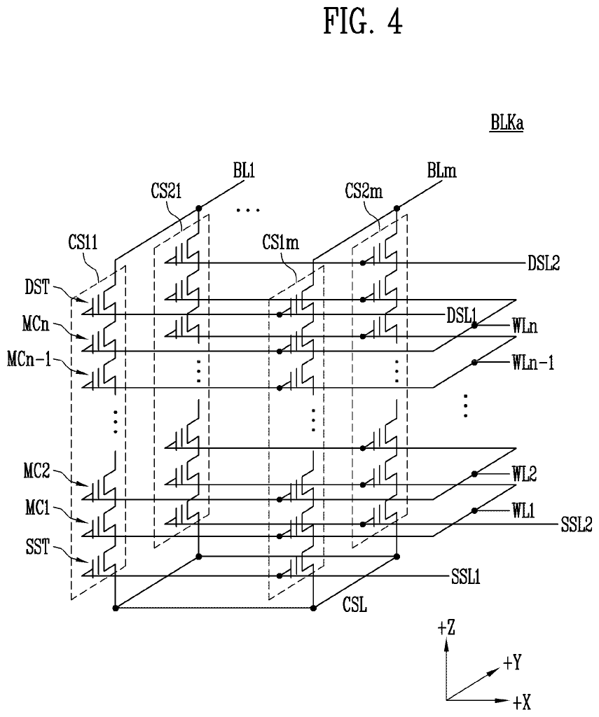

FIG. 4 is a circuit diagram illustrating any one memory block BLKa among the memory blocks BLK1 to BLKz of FIG. 3. The memory block BLKa may be a memory block in a memory cell array having a three-dimensional structure.

The memory block BLKa includes a plurality of cell strings CS11 to CS1m and CS21 to CS2m. In the memory block BLKa, m cell strings are arranged in a row direction (that is, the +X direction). In FIG. 4, two cell strings are arranged in a column direction (that is, the +Y direction). However, this is for convenience of description and it may be understood that three or more cell strings may be arranged in the column direction.

Each of the plurality of cell strings CS11 to CS1m and CS21 to CS2m includes at least one source select transistor SST, first to n-th memory cells MC1 to MCn, and at least one drain select transistor DST.

Each of the select transistors SST and DST and the memory cells MC1 to MCn may have a similar structure. In an embodiment, each of the select transistors SST and DST and the memory cells MC1 to MCn may include a channel layer, a tunneling insulating film, a charge storage film, and a blocking insulating film. In an embodiment, a pillar for providing the channel layer may be provided in each cell string. In an embodiment, a pillar for providing at least one of the channel layer, the tunneling insulating film, the charge storage film, and the blocking insulating film may be provided in each cell string.

The source select transistor SST of each cell string is connected between a common source line CSL and the memory cells MC1 to MCn.

In an embodiment, the source select transistors of the cell strings arranged in the same row are connected to a source select line extending in the row direction, and the source select transistors of the cell strings arranged in different rows are connected to different source select lines. In FIG. 4, the source select transistors of the cell strings CS11 to CS1m of a first row are connected to a first source select line SSL1. The source select transistors of the cell strings CS21 to CS2m of a second row are connected to a second source select line SSL2.

In another embodiment, the source select transistors of the cell strings CS11 to CS1m and CS21 to CS2m may be commonly connected to one source select line.

The first to n-th memory cells MC1 to MCn of each cell string are connected in series between the source select transistor SST and the drain select transistor DST. Gates of the first to n-th memory cells MC1 to MCn are connected to first to n-th word lines WL1 to WLn, respectively.

The drain select transistor DST of each cell string is connected between a corresponding bit line and the memory cells MCp+1 to MCn. Drain select transistors of cell strings arranged in the row direction are connected to the drain select line extending in the row direction. The drain select transistors of the cell strings CS11 to CS1m of the first row are connected to a first drain select line DSL1. The drain select transistors of the cell strings CS21 to CS2m of the second row are connected to a second drain select line DSL2.

The cell strings arranged in the column direction are connected to the bit lines extending in the column direction. In FIG. 3, the cell strings CS11 and CS21 of the first column are connected to the first bit line BL1. The cell strings CS1m and CS2m of the m-th column are connected to the m-th bit line BLm.

The memory cells connected to the same word line in the cell strings arranged in the row direction configure one page. For example, the memory cells connected to the first word line WL1, among the cell strings CS11 to CS1m of the first row configure one page. The memory cells connected to the first word line WL1, among the cell strings CS21 to CS2m of the second row configure another page. The cell strings arranged in one row direction may be selected by selecting any one of the drain select lines DSL1 and DSL2. One page of the selected cell strings may be selected by selecting any one of the word lines WL1 to WLn.

In another embodiment, even bit lines and odd bit lines may be provided instead of the first to m-th bit lines BL1 to BLm. In addition, even-numbered cell strings among the cell strings CS11 to CS1m or CS21 to SC2m arranged in the row direction may be connected to the bit lines, and odd-numbered cell strings among the cell strings CS11 to CS1m or CS21 to CS2m arranged in the row direction may be connected to odd bit lines, respectively.

In an embodiment, at least one of the first to n-th memory cells MC1 to MCn may be used as a dummy memory cell. For example, at least one dummy memory cell is provided to reduce an electric field between the source select transistor SST and the memory cells MC1 to MCp. Alternatively, at least one dummy memory cell is provided to reduce an electric field between the drain select transistor DST and the memory cells MCp+1 to MCn. As more dummy memory cells are provided, reliability of an operation for the memory block BLKa is improved, however, the size of the memory block BLKa increases. As less dummy memory cells are provided, the size of the memory block BLKa may be reduced, however, the reliability of the operation for the memory block BLKa may be reduced.

In order to efficiently control at least one dummy memory cell, each of the dummy memory cells may have a required threshold voltage. Before or after an erase operation for the memory block BLKa, program operations for all or a part of the dummy memory cells may be performed. When the erase operation is performed after the program operation is performed, the dummy memory cells may have the required threshold voltage by controlling a voltage applied to dummy word lines connected to the respective dummy memory cells.

FIG. 5 is a circuit diagram illustrating an embodiment of any one memory block BLKb among the memory blocks BLK1 to BLKz included in the memory cell array 110 of FIG. 2. The memory block BLKb may be a memory block in a memory cell array having a two-dimensional structure.

The memory block BLKb includes a plurality of cell strings CS1 to CSm. The plurality of cell strings CS1 to CSm may be connected to a plurality of bit lines BL1 to BLm, respectively. Each of the cell strings CS1 to CSm includes at least one source select transistor SST, first to n-th memory cells MC1 to MCn, and at least one drain select transistor DST.

Each of the select transistors SST and DST and the memory cells MC1 to MCn may have a similar structure. In an embodiment, each of the select transistors SST and DST and the memory cells MC1 to MCn may include a channel layer, a tunneling insulating film, a charge storage film, and a blocking insulating film. The source select transistor SST of the cell string is connected between a common source line CSL and the memory cells MC1 to MCn.

The first to n-th memory cells MC1 to MCn of each cell string are connected between the source select transistor SST and the drain select transistor DST.

The drain select transistor DST of each cell string is connected between a corresponding bit line and the memory cells MC1 to MCn.

Memory cells connected to the same word line configure one page. The cell strings CS1 to CSm may be selected by selecting the drain select line DSL. One page among the selected cell strings may be selected by selecting any one of the word lines WL1 to WLn.

In another embodiment, even bit lines and odd bit lines may be provided instead of the first to m-th bit lines BL1 to BLm. Even-numbered cell strings among the cell strings CS1 to CSm may be connected to even bit lines, and odd-numbered cell strings may be connected to odd bit lines, respectively.

FIG. 6 is a block diagram illustrating a trim operation controlled by a host device according to an embodiment of the present disclosure.

Referring to FIG. 6, in order to control the storage device 1000 to perform a data trim operation, the host device 300 may generate a trim request RQ_{TRM}. The trim request RQ_{TRM} may include information for identifying data that is a target of the trim operation. For example, the trim request RQ_{TRM} may include one or more logical addresses, such as one or more logical block addresses (LBAs), identifying the data that is the target of the trim operation. The host device 300 may transmit the generated trim request RQ_{TRM} to the controller 200 of the storage device (S61).

The trim request processor 210 of the controller 200 may transmit the read command for reading the map data to the semiconductor memory device 100 in response to receiving the trim request RQ_{TRM}. The semiconductor memory device 100 may read the map data MAP_DATA in response to the received read command, and transmit the read map data MAP_DATA to the controller 200 (S62).

The trim request processor 210 of the controller 200 may update the map data MAP_DATA based on the trim request RQ_{TRM}. Data corresponding to the trim request RQ_{TRM} may be invalidated by the update of the map data MAP_DATA. The trim request processor 210 of the controller 200 may transmit the updated map data MAP_DATA′ (S63) together with a program command for programming the updated map data MAP_DATA′ to the semiconductor memory device 100. The semiconductor memory device 100 may program the updated map data MAP_DATA′ to the memory cell array in response to the program command. Through such a process, a trim operation of data may be performed.

FIGS. 7A and 7B are diagrams illustrating the update of the map data according to the trim operation.

Referring to FIG. 7A, the map data MAP_DATA stored in the semiconductor memory device 100 before being updated is shown. The map data MAP_DATA may include a plurality of logical block addresses (LBAs) and physical block addresses (PBAs) respectively corresponding thereto. More specifically, the map data MAP_DATA may include first to N-th LBAs LBA₁ to LBA_{N} and corresponding PBAs.

More specifically, the first LBA LBA₁ corresponds to the first PBA PBA₁. This may mean that valid data corresponding to the first LBA LBA₁ is stored in the first PBA PBA₁. Meanwhile, the second LBA LBA₂ corresponds to the second PBA PBA₂. This may mean that valid data corresponding to the second LBA LBA₂ is stored in the second PBA PBA₂.

Referring to FIG. 7A, the map data MAP_DATA does not include a PBA corresponding to the third LBA LBA₃. This may mean that valid data corresponding to the third LBA LBA₃ does not exist. New data corresponding to the third LBA LBA₃ may be stored in the storage device 1000. Similarly, valid data is not allocated to the M-th LBA LBA_{M}, and thus the corresponding PBA is not included in the map data MAP_DATA.

In such a process, the map data MAP_DATA may include the PBAs corresponding to the first to N-th LBAs LBA₁ to LBA_{N}, respectively. Among the first to N-th LBAs LBA₁ to LBA_{N}, in a case of an LBA for which valid data does not exist, a corresponding PBA does not exist.

Referring to FIG. 7A, a situation in which the controller 200 receives a trim request RQ_{TRM} corresponding to an i-th LBA LBAᵢ is shown. Accordingly, data corresponding to the i-th LBA LBAᵢ is trimmed.

The i-th LBA LBAᵢ corresponds to an i-th PBA PBAᵢ. This may mean that valid data corresponding to the i-th LBA LBAᵢ is stored in the i-th PBA PBAᵢ. When the trim request RQ_{TRM} corresponding to the i-th LBA LBAᵢ, is received, the trim request processor 210 may invalidate the valid data corresponding to the i-th LBA LBAᵢ. In order to invalidate the valid data, the trim request processor 210 removes the i-th PBA PBAᵢ corresponding to the i-th LBA LBAᵢ from the map data MAP_DATA.

Referring to FIG. 7B, the map data MAP_DATA′ updated in response to the trim request RQ_{TRM} is shown. The i-th PBA PBAᵢ corresponding to the i-th LBA LBAᵢ is removed from the map data MAP_DATA′. As a result, data corresponding to the i-th LBA LBA₁ is still stored in the i-th PBA PBAᵢ of the semiconductor memory device 100, but is reclassified as invalid data. The invalid data stored in the i-th PBA PBAᵢ may later be erased by a garbage collection operation.

As described above, the storage device 1000 may perform the trim operation corresponding to the trim request RQ_{TRM} by updating the map data MAP_DATA stored in the semiconductor memory device 100.

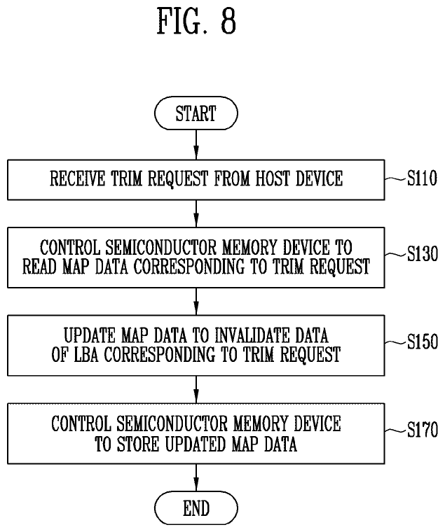

FIG. 8 is a flowchart illustrating a process of operating a storage device according to an embodiment of the present disclosure.

Referring to FIG. 8, the process of operating the storage device according to an embodiment of the present disclosure includes receiving the trim request from the host device (S110), controlling the semiconductor memory device to read the map data corresponding to the trim request (S130), updating the map data to invalidate the data of the LBA corresponding to the trim request (S150), and controlling the semiconductor memory device to store the updated map data (S170).

In step S110, the controller 200 of the storage device 1000 receives the trim request RQ_{TRM} for specific data from the host device 300.

In step S130, the trim request processor 210 generates the read command for reading the map data MAP_DATA including the LBA corresponding to the trim request RQ_{TRM} and transmits the generated read command to the semiconductor memory device 100. The semiconductor memory device 100 may read the map data MAP_DATA including the LBA corresponding to the trim request RQ_{TRM} in response to the received read command, and transmit the read map data MAP_DATA to the controller 200.

In step S150, the trim request processor 210 updates the map data MAP_DATA based on the trim request RQ_{TRM}. As described with reference to FIGS. 7A and 7B, the trim request processor 210 may update the map data MAP_DATA to invalidate the data corresponding to the trim request RQ_{TRM}.

In step S170, the controller 200 of the storage device 1000 transmits the updated map data MAP_DATA′ and the program command for programming the updated map data MAP_DATA′ to the semiconductor memory device 100. The semiconductor memory device 100 may program the updated map data MAP_DATA′, in response to the received program command.

According to the process described with reference to FIGS. 6 to 8, the storage device 1000 may immediately perform the trim operation whenever the storage device 1000 receives the trim request from the host device 300. As described with reference to FIGS. 6 to 8, in order to perform the trim operation, an operation of reading the map data stored in the semiconductor memory device 100 and storing the updated map data back in the semiconductor memory device 100 is required. In such a process, when the host device 300 frequently generates trim requests and transmits the trim requests to the storage device 1000, the storage device 1000 is required to repeatedly perform an operation of reading and updating the map data and storing the updated map data in the semiconductor memory device whenever the trim request is received. This may be a factor in reducing an operation efficiency of the storage device 1000.

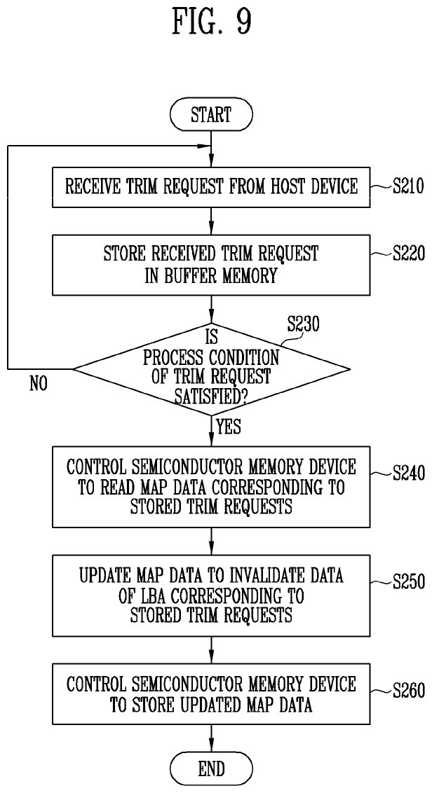

According to another embodiment of the present disclosure, the storage device 1000 may store a plurality of trim requests received from the host device in a buffer memory and perform a single trim operation corresponding to the plurality of trim requests stored in the buffer memory. In this case, even though the host device 300 frequently generates trim requests and transmits the trim requests to the storage device 1000, because the storage device 1000 may collect the trim requests and process the collected trim requests as one trim operation, the number of times the read operation and the program operation of the map data are performed may be reduced. Through this, the operation efficiency of the storage device 1000 may be improved. Hereinafter, a description of such an embodiment is provided with reference to FIG. 9.

FIG. 9 is a flowchart illustrating a process of operating a storage device according to another embodiment of the present disclosure.

Referring to FIG. 9, the process of operating the storage device according to another embodiment of the present disclosure includes receiving a trim request from the host device (S210), storing the received trim request in the buffer memory (S220), determining whether a process condition of the trim request is satisfied (S230), controlling the semiconductor memory device to read the map data corresponding to the stored trim requests (S240), updating the map data to invalidate the data of LBAs corresponding to the stored trim requests (S250), and controlling the semiconductor memory device to store the updated map data (S260).

In step S210, the controller 200 of the storage device 1000 may receive the trim request RQ_{TRM} for specific data from the host device 300. In step S220, the controller 200 of the storage device 1000 may store the received trim request RQ_{TRM} in the buffer memory, rather than immediately processing the received trim request RQ_{TRM}. Accordingly, a plurality of trim requests may be stored in the buffer memory.

In step S230, the controller 200 determines whether a condition for processing the trim requests stored in the buffer memory is satisfied. The process condition of the trim request may be variously determined according to an embodiment. That is, even though the storage device performs the trim operation, a process condition that allows the trim operation to be performed without reducing or with less reduction of an operation efficiency of the storage device 1000 may be determined.

As an example, the storage device 1000 may perform the trim operation every predetermined period. In this case, the process condition of the trim request may be, for example, “Has a predetermined threshold time elapsed from a time when a previous trim operation was performed?”. When the predetermined threshold time has elapsed from the time when the previous trim operation was performed, it may be determined that the process condition of the trim request is satisfied. When the predetermined threshold time has not elapsed from the time when the previous trim operation was performed, it may be determined that the process condition of the trim request is not satisfied.

As another example, the storage device 1000 may perform the trim operation during an idle time. In this case, the process condition of the trim request may be, for example, “Is the storage device 1000 currently in an idle state?”. When the storage device 1000 is currently in the idle state, it may be determined that the process condition of the trim request is satisfied. When the storage device 1000 is currently not in the idle state, it may be determined that the process condition of the trim request is not satisfied. In addition, various process conditions may be applied in step S230 according to an embodiment.

When the process condition of the trim request is not satisfied (S230: No), the process may proceed to step S210 to receive another trim request from the host device. Accordingly, when the process condition of the trim request is not satisfied, the trim operation may not be performed and the received trim requests are accumulated and stored in the buffer memory.

When the process condition of the trim request is satisfied (S230: Yes), the storage device 1000 may perform the trim operation corresponding to the trim requests stored in the buffer memory. More specifically, in step S240, the trim request processor 210 may generate a read command for reading the map data MAP_DATA including the LBAs corresponding to the trim requests RQ_{TRM} stored in the buffer memory, and may transmit the generated read command to the semiconductor memory device 100. The semiconductor memory device 100 may read the map data MAP_DATA including the LBAs corresponding to the trim requests RQ_{TRM}, in response to the received read command, and transmit the read map data MAP_DATA to the controller 200.

In step S250, the trim request processor 210 may update the map data MAP_DATA based on the trim requests RQ_{TRM} stored in the buffer memory. Similarly to as described with reference to FIGS. 7A and 7B, the trim request processor 210 may update the map data MAP_DATA to invalidate the data corresponding to one or more of the trim requests RQ_{TRM} stored in the buffer memory. After the data corresponding to the trim requests RQ_{TRM} stored in the buffer memory has been invalidated, the trim requests RQ_{TRM} may be removed from the buffer memory.

In step S260, the controller 200 of the storage device 1000 may transmit the updated map data MAP_DATA′ and the program command for programming the updated map data MAP_DATA′ to the semiconductor memory device 100. The semiconductor memory device 100 may program the updated map data MAP_DATA′, in response to the received program command.

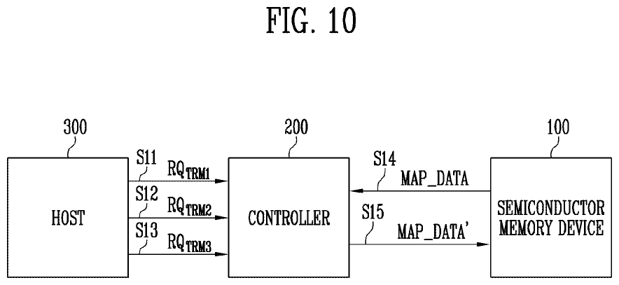

FIG. 10 is a block diagram illustrating the trim operation performed by the operation process of FIG. 9. Hereinafter, the trim operation according to an embodiment of the present disclosure is described with reference to FIGS. 9 and 10 together.

Referring to FIG. 10, in order to control the storage device 1000 to perform a trim operation of first data, the host device 300 may generate a first trim request RQ_{TRM1}. The first trim request RQ_{TRM1} may include information for identifying the first data that is to be the target of the trim operation. The host device 300 may transmit the generated first trim request RQ_{TRM1} to the controller 200 of the storage device (S11).

The storage device 1000 receives the first trim request RQ_{TRM1} from the host device 300 (S210). The controller 200 of the storage device 1000 stores the first trim request RQ_{TRM1} in the buffer memory (S220). Thereafter, the trim request processor 210 of the controller 200 determines whether the process condition of the trim request is satisfied (S230).

FIG. 10 shows a situation in which the process condition of the trim request is not satisfied at a time point when the first trim request RQ_{TRM1} is received. Therefore, the trim request processor 210 determines that the process condition of the trim request is not satisfied (S230: No).

Thereafter, in order to control the storage device 1000 to perform a trim operation of second data different from the first data, the host device 300 may generate a second trim request RQ_{TRM2}. The second trim request RQ_{TRM2} may include information for identifying the second data that is to be the target of the trim operation. The host device 300 may transmit the generated second trim request RQ_{TRM2} to the controller 200 of the storage device (S12).

The storage device 1000 receives the second trim request RQ_{TRM2} from the host device 300 (S210). The controller 200 of the storage device 1000 stores the second trim request RQ_{TRM2} in the buffer memory (S220). Thereafter, the trim request processor 210 of the controller 200 determines whether the process condition of the trim request is satisfied (S230).

FIG. 10 shows a situation in which the process condition of the trim request is not satisfied at a time point when the second trim request RQ_{TRM2} is received. Therefore, the trim request processor 210 determines that the process condition of the trim request is not satisfied (S230: No).

Thereafter, in order to control the storage device 1000 to perform a trim operation of third data different from the first and second data, the host device 300 may generate a third trim request RQ_{TRM3}. The third trim request RQ_{TRM3} may include information for identifying the third data that is to be the target of the trim operation. The host device 300 may transmit the generated third trim request RQ_{TRM3} to the controller 200 of the storage device (S13).

The storage device 1000 receives the third trim request RQ_{TRM3} from the host device 300 (S210). The controller 200 of the storage device 1000 stores the third trim request RQ_{TRM3} in the buffer memory (S220). Thereafter, the trim request processor 210 of the controller 200 determines whether the process condition of the trim request is satisfied (S230).

FIG. 10 shows a situation in which the process condition of the trim request is satisfied at a time point when the third trim request RQ_{TRM3} is received. Therefore, the trim request processor 210 determines that the process condition of the trim request is satisfied (S230: Yes).

In response to determination that the process condition of the trim request is satisfied, the storage device 1000 may transmit a read command for reading map data corresponding to the first, second, and third trim requests RQ_{TRM1}, RQ_{TRM2}, and RQ_{TRM3} stored in the buffer memory to the semiconductor memory device 100. The semiconductor memory device 100 may read the map data MAP_DATA in response to the received read command, and transmit the read map data MAP_DATA to the controller 200 (S14).

The trim request processor 210 of the controller 200 may update the map data MAP_DATA based on the first, second, and third trim requests RQ_{TRM1}, RQ_{TRM2}, and RQ_{TRM3}. Data corresponding to the first, second, and third trim requests RQ_{TRM1}, RQ_{TRM2}, and RQ_{TRM3} may be invalidated by the update of the map data MAP_DATA. The trim request processor 210 of the controller 200 may transmit the updated map data MAP_DATA′ to the semiconductor memory device 100 (S15) together with the program command for programming the updated map data MAP_DATA′ to the semiconductor memory device 100. The semiconductor memory device 100 may program the updated map data MAP_DATA′ to the memory cell array, in response to the program command. According to such a process, the trim operation of data may be performed.

According to the process shown in FIGS. 9 and 10, the storage device 1000 may store one or more trim requests received from the host device in the buffer memory, and perform the trim operation corresponding to the one or more trim requests stored in the buffer memory at once. In this case, even though the host device 300 frequently generates the trim requests and transmits the trim requests to the storage device 1000, since the storage device 1000 may collect the trim requests and process multiple trim requests as one trim operation, the number of times the read operation and the program operation of the map data are performed may be reduced .

However, when a sudden power off (SPO) occurs in the storage device while a trim request received from the host device 300 is being stored in the buffer memory, the trim request stored in the buffer memory may be lost. When the host device 300 transmits the trim request to the storage device 1000, but the storage device 1000 loses the trim request before performing the trim operation, an error may occur in a data process of the host device 300 and the storage device 1000.

In accordance with the process of operating the host device 300 according to an embodiment of the present disclosure, after a trim request of data corresponding to a specific LBA is transmitted to the storage device 1000, a trim request for the same data may be re-transmitted to the storage device 1000 according to a predetermined requirement. Accordingly, even though the SPO occurs, the storage device 1000 may reliably perform the trim operation.

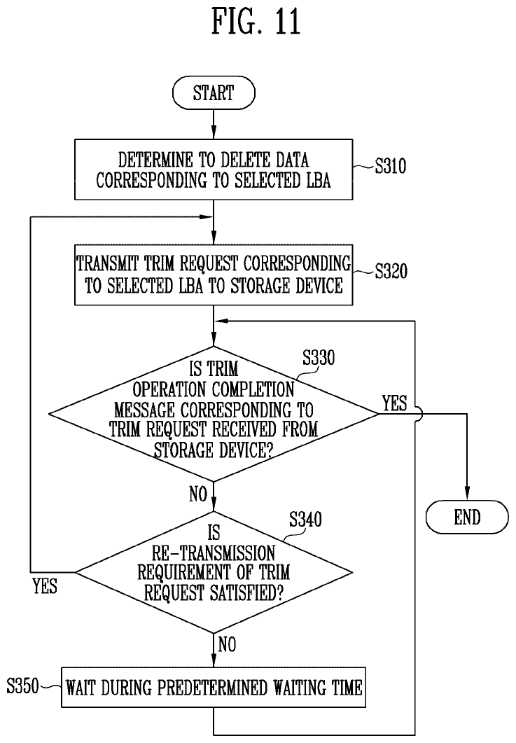

FIG. 11 is a flowchart illustrating a process of operating a host device according to an embodiment of the present disclosure.

Referring to FIG. 11, the process of operating the host device according to an embodiment of the present disclosure includes determining to delete data corresponding to a selected LBA (S310), transmitting a trim request RQ_{TRM} corresponding to the selected LBA to the storage device 1000 (S320), determining whether a trim operation completion message corresponding to the trim request RQ_{TRM} has been received from the storage device 1000 (S330), determining whether a re-transmission requirement of the trim request is satisfied (S340), and waiting during a predetermined waiting time (S350).

In step S310, the trim controller 310 of the host device 300 may determine to delete the data corresponding to the selected LBA among the plurality of LBAs. For example, when a specific file stored in the storage device 1000 is deleted from a file system of the host device 300, the trim controller 310 may select an LBA corresponding to the deleted file and determine to delete the data corresponding to the selected LBA.

In step S320, the trim controller 310 of the host device 300 transmits the trim request corresponding to the selected LBA to the storage device. When a size of the file to be deleted is small, the selected LBA may be one LBA. When the size of the file to be deleted is large, the selected LBA may include a plurality of LBAs.

In step S330, the trim controller 310 of the host device 300 determines whether the trim operation completion message corresponding to the trim request has been received from the storage device 1000. In response to the trim request transmitted in step S320, the storage device 1000 may immediately perform the trim operation or may perform the trim operation when the process condition of the trim request is satisfied. When the storage device 1000 completes the trim operation, the storage device 1000 may transmit the trim operation completion message to the host device 300. That is, reception of the trim operation completion message by the host device 300 means that the trim operation corresponding to the trim request transmitted to the storage device 1000 in step S320 has been performed. In an embodiment, the trim operation completion message may include information indicating one or more corresponding trim requests that have been completed.

When the trim operation completion message corresponding to the trim request has been received from the storage device 1000 (S330: Yes), the corresponding trim request does not need to be re-transmitted to the storage device 1000. Therefore, an operation related to the trim request of the data corresponding to the selected LBA is ended.

In a case where the trim operation completion message corresponding to the trim request has not been received from the storage device 1000 (S330: No), the case means that the trim operation corresponding to the trim request transmitted to the storage device 1000 in step S320 is not yet performed. In this case, the trim controller 310 of the host device 300 determines whether a requirement for re-transmitting the trim request to the storage device 1000 is satisfied (S340). The re-transmission requirement of the trim request may be variously determined according to an embodiment. As an example, the host device 300 may re-transmit the trim request to the storage device 1000 every predetermined period. In this case, the re-transmission requirement of the trim request may be, for example, “Has a predetermined threshold time elapsed from the last time point when the trim request corresponding to the selected LBA was transmitted to the storage device?”. When the predetermined threshold time has elapsed from the time point when the trim request corresponding to the selected LBA is transmitted to the storage device 1000, it may be determined that the re-transmission requirement of the trim request is satisfied. When the predetermined threshold time has not elapsed from the time point when the trim request corresponding to the selected LBA is transmitted to the storage device 1000, it may be determined that the re-transmission requirement of the trim request is not satisfied.

When the re-transmission requirement of the trim request is not satisfied (S340: No), after waiting during the predetermined waiting time (S350), it is determined again whether the trim operation completion message corresponding to the trim request has been received from the storage device 1000(S330).

When the re-transmission requirement of the trim request is satisfied (S340: Yes), the process proceeds to step S320 and transmits the trim request corresponding to the selected LBA to the storage device 1000 again (S320), and the trim controller 310 of the host device 300 determines whether the trim operation completion message corresponding to the trim request is received from the storage device 1000 (S330). In such a process, after transmitting the trim request for data corresponding to a specific LBA to the storage device 1000, the host device 300 may re-transmit the trim request for the same data to the storage device 1000 according to a predetermined requirement. Accordingly, even though the SPO occurs, the storage device 1000 may reliably perform the trim operation.

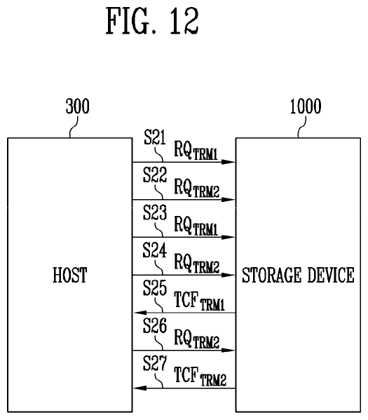

FIG. 12 is a block diagram illustrating the trim operation performed by the operation process of FIG. 11.

The host device 300 may transmit the first trim request RQ_{TRM1} corresponding to the first data to the storage device 1000 (S21). Meanwhile, independently of the transmission of the first trim request RQ_{TRM1}, the host device 300 may transmit the second trim request RQ_{TRM2} corresponding to the second data to the storage device 1000 (S22).

In a case where a trim operation completion message corresponding to the first trim request RQ_{TRM1} is not received from the storage device 1000 (S330: No), when the re-transmission requirement of the trim request is satisfied (S340: Yes), the host device 300 may re-transmit the first trim request RQ_{TRM1} corresponding to the first data to the storage device 1000 (S23). Similarly, in a case where a trim operation completion message corresponding to the second trim request RQ_{TRM2} is not received from the storage device 1000 (S330: No), when the re-transmission requirement of the trim request is satisfied (S340: Yes), the host device 300 may re-transmit the second trim request RQ_{TRM2} corresponding to the second data to the storage device 1000 (S24).

Thereafter, when the storage device 1000 performs the trim operation corresponding to the first trim request RQ_{TRM1}, the storage device 1000 may transmit a first trim operation completion message TCF_{TRM1} corresponding to the first trim request RQ_{TRM1} to the host device 300 (S25). In response to reception of the first trim operation completion message TCF_{TRM1} (S330: Yes), the host device 300 may not re-transmit the first trim request RQ_{TRM1} to the storage device 1000 any more.

Meanwhile, when the host device 300 does not receive the trim operation completion message corresponding to the second trim request RQ_{TRM2} from the storage device 1000 (S330: No), the host device 300 may re-transmit the second trim request RQ_{TRM2} corresponding to the second data to the storage device 1000 (S26). Thereafter, when the storage device 1000 performs the trim operation corresponding to the second trim request RQ_{TRM2}, the storage device 1000 may transmit a second trim operation completion message TCF_{TRM2} corresponding to the second trim request RQ_{TRM2} to the host device 300 (S27). In response to reception of the second trim operation completion message TCF_{TRM2} (S330: Yes), the host device 300 may not re-transmit the second trim request RQ_{TRM2} to the storage device 1000.

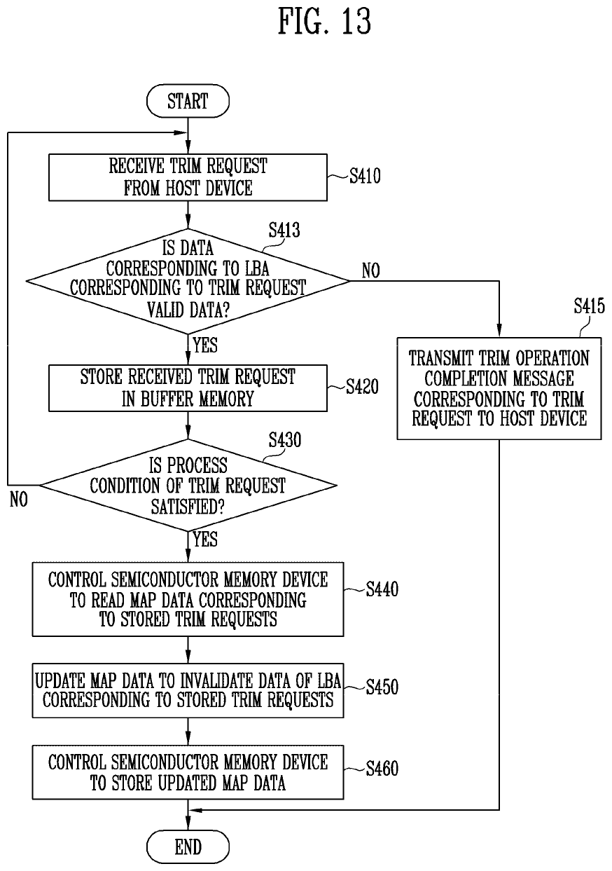

FIG. 13 is a flowchart illustrating a process of operating a storage device according to still another embodiment of the present disclosure. Specifically, FIG. 13 illustrates a process of operating the storage device corresponding to the process of operating the host device according to FIG. 11.

Referring to FIG. 13, the process of operating the storage device according to still another embodiment of the present disclosure includes receiving the trim request from the host device (S410), determining whether data corresponding to an LBA corresponding to the received trim request is valid data (S413), transmitting the trim operation completion message corresponding to the trim request to the host device (S415), storing the received trim request in the buffer memory (S420), determining whether the process condition of the trim request is satisfied (S430), controlling the semiconductor memory device to read the map data corresponding to the stored trim requests (S440), updating the map data to invalidate the data of the LBA corresponding to the stored trim requests (S450), and controlling the semiconductor memory device to store the updated map data (S460).

In step S410, the controller 200 of the storage device 1000 may receive the trim request RQ_{TRM} for specific data from the host device 300. Since the trim request received in step S410 may be a re-transmitted trim request instead of an initially-received trim request, the storage device 1000 determines whether the data corresponding to the LBA corresponding to the received trim request is valid data (S413). In an embodiment, determining whether the data corresponding to the LBA corresponding to the received trim request is valid data is performed by determining whether map data includes a PBA corresponding to the LBA. When the data corresponding to the LBA corresponding to the received trim request is invalid data (S413: No), this means that the trim operation corresponding to the received trim request has already been performed. Accordingly, a trim operation completion message corresponding to the received trim request is transmitted to the host device (S415).

When the data corresponding to the LBA corresponding to the received trim request is valid data (S413: Yes), the controller 200 of the storage device 1000 may store the received trim request RQ_{TRM} in the buffer memory (S420). Accordingly, a plurality of trim requests may be stored in the buffer memory.

In step S430, the controller 200 determines whether a condition for processing the trim requests stored in the buffer memory is satisfied. The process condition of the trim request may be variously determined according to an embodiment. That is, even though the storage device performs the trim operation, the process condition that allows the trim operation to be performed without reducing or with less reduction of the operation efficiency of the storage device 1000 may be determined.

When the process condition of the trim request is not satisfied (S430: No), the process may proceed to step S410 to receive another trim request from the host device. Accordingly, when the process condition of the trim request is not satisfied, the trim operation may not be performed and the received trim requests are accumulated and stored in the buffer memory.

When the process condition of the trim request is satisfied (S430: Yes), the storage device 1000 may perform the trim operation corresponding to the trim requests stored in the buffer memory. More specifically, in step S440, the trim request processor 210 may generate a read command for reading the map data MAP_DATA including the LBAs corresponding to the trim request(s) RQ_{TRM} stored in the buffer memory, and may transmit the generated read command to the semiconductor memory device 100. The semiconductor memory device 100 may read the map data MAP_DATA including the LBAs corresponding to the trim requests RQ_{TRM}, in response to the received read command, and transmit the read map data MAP_DATA to the controller 200.

In step S450, the trim request processor 210 may update the map data MAP_DATA based on the trim requests RQ_{TRM} stored in the buffer memory. Similarly to that described with reference to FIGS. 7A and 7B, the trim request processor 210 may update the map data MAP_DATA to invalidate data corresponding to the at least one trim request RQ_{TRM} stored in the buffer memory. After the data corresponding to the at least one trim requests RQ_{TRM} stored in the buffer memory has been invalidated, the at least one trim requests RQ_{TRM} may be removed from the buffer memory.

In step S460, the controller 200 of the storage device 1000 may transmit the updated map data MAP_DATA′ and the program command for programming the updated map data MAP_DATA′ to the semiconductor memory device 100. The semiconductor memory device 100 may program the updated map data MAP_DATA′, in response to the received program command.

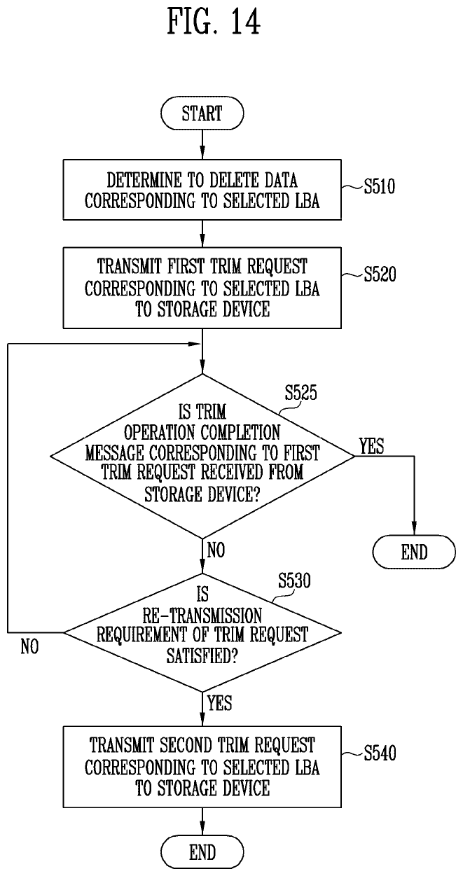

FIG. 14 is a flowchart illustrating a process of operating a host device according to another embodiment of the present disclosure.

According to the embodiment of FIG. 11 described above, when the host device 300 does not receive the trim operation completion message, the host device 300 repeatedly re-transmits the trim request to the storage device. In some cases, too many trim requests corresponding to one LBA may be transmitted to the storage device. In a case of the embodiment shown in FIG. 14, a situation in which too many trim requests are re-transmitted is prevented.

Referring to FIG. 14, the process of operating the host device according to another embodiment of the present disclosure includes determining to delete the data corresponding to the selected LBA (S510), transmitting the first trim request corresponding to the selected LBA to the storage device 1000 (S520), determining whether a trim operation completion message corresponding to the first trim request has been received from the storage device 1000 (S525), determining whether the re-transmission requirement of the trim request is satisfied (S530), and transmitting the second trim request corresponding to the selected LBA to the storage device 1000 (S540).

In step S510, the trim controller 310 of the host device 300 may determine to delete the data corresponding to the selected LBA among the plurality of LBAs. For example, when a specific file stored in the storage device 1000 is deleted from a file system of the host device 300, the trim controller 310 may select an LBA corresponding to the deleted file and determine to delete the data corresponding to the selected LBA.

In step S520, the trim controller 310 of the host device 300 transmits the first trim request corresponding to the selected LBA to the storage device. When a size of the file to be deleted is small, the selected LBA may be one LBA. When the size of the file to be deleted is large, the selected LBA may include a plurality of LBAs. The first trim request may be a trim request initially transmitted to the storage device 1000 in response to the selected LBA.

In step S525, the trim controller 310 of the host device 300 determines whether the trim operation completion message corresponding to the first trim request has been received from the storage device 1000. The reception of the trim operation completion message by the host device 300 means that the trim operation corresponding to the first trim request transmitted to the storage device 1000 in step S520 has been performed.

When the trim operation completion message corresponding to the first trim request has been received from the storage device 1000 (S525: Yes), the first trim request does not need to be re-transmitted to the storage device 1000. Therefore, an operation related to the first trim request of the data corresponding to the selected LBA is ended.

In a case where the trim operation completion message corresponding to the first trim request has not been received from the storage device 1000 (S525: No), the case means that the trim operation corresponding to the trim request transmitted to the storage device 1000 in step S520 has not yet been performed, and the process proceeds to S530.

Thereafter, in step S530, the host device 300 determines whether the re-transmission requirement of the trim request is satisfied. When the re-transmission requirement of the trim request is not satisfied (S530: No), the host device may re-determine whether the trim operation completion message corresponding to the first trim request has been received and whether the re-transmission requirement of the trim request is satisfied every predetermined time.

When the re-transmission requirement of the trim request is satisfied (S530: Yes), the host device 300 transmits the second trim request corresponding to the selected LBA to the storage device. The second trim request transmitted to the storage device in step S540 may correspond to the same LBA as the first trim request transmitted to the storage device in step S520. However, the first trim request and the second trim request may be different types of trim requests. In an embodiment, the first trim request may be a trim request allowing the storage device 1000 to perform a corresponding trim operation later. When the storage device 1000 receives the first trim request, the trim operation corresponding to the first trim request may be immediately performed according to a state of the storage device 1000, or the trim operation may be performed later by storing the first trim request in the buffer memory.

In contrast, the second trim request may be a trim request forcing the storage device 1000 to immediately perform a corresponding trim operation. When the storage device 1000 receives the second trim request, the storage device 1000 may be configured to immediately perform a corresponding trim operation.

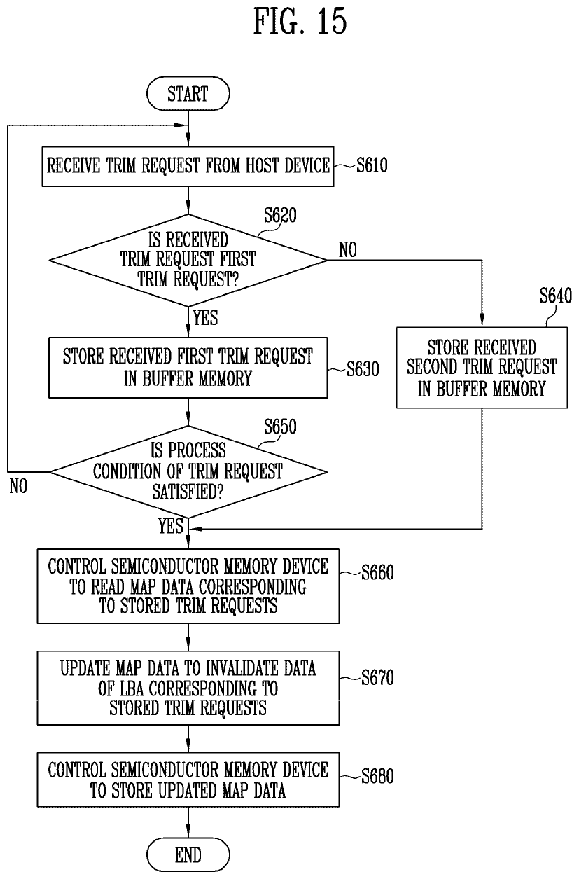

FIG. 15 is a flowchart illustrating a process of operating a storage device according to still another embodiment of the present disclosure.

Referring to FIG. 15, the process of operating the storage device according to still another embodiment of the present disclosure includes receiving the trim request from the host device (S610), determining whether the received trim request is the first trim request (S620), storing the received first trim request in the buffer memory (S630), storing the received second trim request in the buffer memory (S640), determining whether the process condition of the trim request is satisfied (S650), controlling the semiconductor memory device to read the map data corresponding to the stored trim requests (S660), updating the map data to invalidate the data of the LBAs corresponding to the stored trim requests (S670), and controlling the semiconductor memory device to store the updated map data (S680).

In step S610, the controller 200 of the storage device 1000 may receive the trim request RQ_{TRM} for specific data from the host device 300. In step S620, it is determined whether the received trim request is a first trim request or a second trim request. In an embodiment, whether the received trim request is a first or second trim request may be indicated by information in the received trim request. When the received trim request is the first trim request (S620: Yes), the controller 200 of the storage device 1000 may store the received first trim request in the buffer memory (S630). Thereafter, the storage device 1000 may determine whether the process condition of the trim request is satisfied (S650). When the process condition of the trim request is not satisfied (S650: No), the process may proceed to step S610 to receive another trim request from the host device. That is, when the received trim request is the first trim request, the corresponding trim operation may not be immediately performed according to whether the process condition of the trim request is satisfied.

When the received trim request is the second trim request (S620: No), the controller 200 of the storage device 1000 may store the received second trim request in the buffer memory (S640). Thereafter, the storage device 1000 proceeds to step S660 and starts the trim operation corresponding to the trim request stored in the buffer memory, regardless of whether the process condition of the trim request is satisfied. That is, in a case of the second trim request, the corresponding trim operation is immediately performed regardless of whether the process condition of the trim request is satisfied.

In step S660, the storage device 1000 may perform the trim operation corresponding to the trim requests stored in the buffer memory. More specifically, in step S660, the trim request processor 210 may generate the read command for reading the map data MAP_DATA including the LBAs corresponding to the trim requests RQ_{TRM} stored in the buffer memory, and may transmit the generated read command to the semiconductor memory device 100. The semiconductor memory device 100 may read the map data MAP_DATA including the LBA corresponding to the trim requests RQ_{TRM}, in response to the received read command, and transmit the read map data MAP_DATA to the controller 200.

In step S670, the trim request processor 210 may update the map data MAP_DATA based on the trim requests RQ_{TRM} stored in the buffer memory. Similarly to that described with reference to FIGS. 7A and 7B, the trim request processor 210 may update the map data MAP_DATA to invalidate data corresponding to the at least one trim request RQ_{TRM} stored in the buffer memory.

In step S680, the controller 200 of the storage device 1000 may transmit the updated map data MAP_DATA′ and the program command for programming the updated map data MAP_DATA′ to the semiconductor memory device 100. The semiconductor memory device 100 may program the updated map data MAP_DATA′, in response to the received program command.

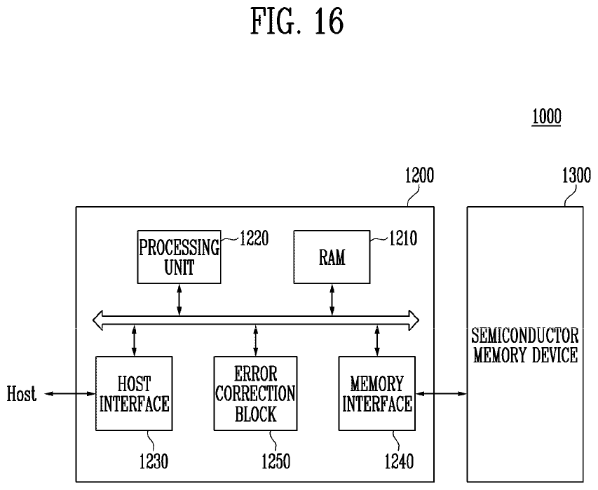

FIG. 16 is a block diagram illustrating a storage device 1000 including a semiconductor memory device and a controller.

The semiconductor memory device 1300 of FIG. 16 may be configured and operate similarly to the semiconductor memory device 100 described with reference to FIG. 2. Hereinafter, repetitive description is omitted.

The controller 1200 is connected to a host device Host and the semiconductor memory device 1300. The controller 1200 is configured to access the semiconductor memory device 1300 in response to a request from the host device Host. For example, the controller 1200 is configured to control read, program, erase, and background operations of the semiconductor memory device 1300. The controller 1200 is configured to provide an interface between the semiconductor memory device 1300 and the host device Host. The controller 1200 is configured to execute firmware for controlling the semiconductor memory device 1300.

The controller 1200 includes a random access memory (RAM) 1210, a processing unit 1220, a host interface 1230, a memory interface 1240, and an error correction block 1250.

The RAM 1210 is used as any one of an operation memory of the processing unit 1220, a cache memory between the semiconductor memory device 1300 and the host device Host, and a buffer memory between the semiconductor memory device 1300 and the host device Host.

The processing unit 1220 controls an overall operation of the controller 1200. The processing unit 1220 is configured to control the read, program, erase, and background operations of the semiconductor memory device 1300. The processing unit 1220 is configured to execute firmware for controlling the semiconductor memory device 1300. The processing unit 1220 may perform a function of a flash translation layer (FTL). The processing unit 1220 may convert a logical block address (LBA) provided by the host device into a physical block address (PBA) through the FTL. The FTL may receive the logical block address (LBA) and convert the LBA into the PBA using a mapping table. There are several address mapping processes of the FTL according to a mapping unit. A representative address mapping process includes a page mapping process, a block mapping process, and a hybrid mapping process.

The host interface 1230 includes a protocol for performing data exchange between the host device Host and the controller 1200. In an example embodiment, the controller 1200 is configured to communicate with the host device Host through at least one of various interface protocols such as a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA protocol, a parallel-ATA protocol, a small computer system interface (SCSI) protocol, an enhanced small disk interface (ESDI) protocol, an integrated drive electronics (IDE) protocol, or a private protocol.

The memory interface 1240 interfaces with the semiconductor memory device 1300. For example, the memory interface 1240 includes a NAND flash memory interface or a NOR flash memory interface.

The error correction block 1250 is configured to detect and correct an error of data received from the semiconductor memory device 1300 using an error correcting code (ECC). The error correction block 1250 may correct an error by using the ECC in the read page data. The error correction block 1250 may correct an error by using a coded modulation such as a low density parity check (LDPC) code, a Bose, Chaudhri, Hocquenghem (BCH) code, a turbo code, a Reed-Solomon code, a convolution code, a recursive systematic code (RSC), a trellis-coded modulation (TCM), a block coded modulation (BCM), or a hamming code.

During a read operation, the error correction block 1250 may correct an error of the read page data. Decoding may be failed when the read page data includes error bits that exceed a correctable number of bits. The decoding may be successful when the page data includes error bits equal to or less than the correctable number of bits. The success of the decoding indicates that a read command is passed. The failure of the decoding indicates that the read command is failed. When the decoding is successful, the controller 1200 outputs the page data in which the error is corrected to the host.

The controller 1200 and the semiconductor memory device 1300 may be integrated into one semiconductor device. In an example embodiment, the controller 1200 and the semiconductor memory device 1300 may be integrated into one semiconductor device to configure a memory card. For example, the controller 1200 and the semiconductor memory device 1300 may be integrated into one semiconductor device to configure a memory card such as a PC card (personal computer memory card international association (PCMCIA)), a compact flash card (CF), a smart media card (SM or SMC), a memory stick, a multimedia card (MMC, RS-MMC, or MMCmicro), an SD card (SD, miniSD, microSD, or SDHC), or a universal flash storage (UFS).

The controller 1200 and the semiconductor memory device 1300 may be integrated into one semiconductor device to configure a semiconductor drive (solid state drive (SSD)). The semiconductor drive (SSD) includes a storage device configured to store data in the semiconductor memory. When the storage device is used as the semiconductor drive (SSD), an operation speed of the host device Host connected to the storage device is dramatically improved.

As another example, the storage device 1000 is provided as one of various components of an electronic device such as a computer, an ultra-mobile PC (UMPC), a workstation, a net-book, a personal digital assistants (PDA), a portable computer, a web tablet, a wireless phone, a mobile phone, a smart phone, an e-book, a portable multimedia player (PMP), a portable game machine, a navigation device, a black box, a digital camera, a 3-dimensional television, a digital audio recorder, a digital audio player, a digital picture recorder, a digital picture player, a digital video recorder, a digital video player, a device capable of transmitting and receiving information in a wireless environment, one of various electronic devices configuring a home network, one of various electronic devices configuring a computer network, one of various electronic devices configuring a telematics network, an RFID device, or one of various components configuring a computing system.

In an example embodiment, the semiconductor memory device 1300 or the storage device may be mounted as a package of various types. For example, the semiconductor memory device 1300 or the storage device may be packaged and mounted in a package such as a package on package (PoP), ball grid arrays (BGAs), chip scale packages (CSPs), plastic leaded chip carriers (PLCC), a plastic dual in line package (PDIP), a die in waffle pack, die in wafer form, a chip on board (COB), a ceramic dual in line package (CERDIP), a plastic metric quad flat pack (MQFP), a thin quad flat pack (TQFP), a small outline integrated circuit (SOIC) package, a shrink small outline package (SSOP), a thin small outline package (TSOP), a system in package (SIP), a multi-chip package (MCP), a wafer-level fabricated package (WFP), or a wafer-level processed stack package (WSP).

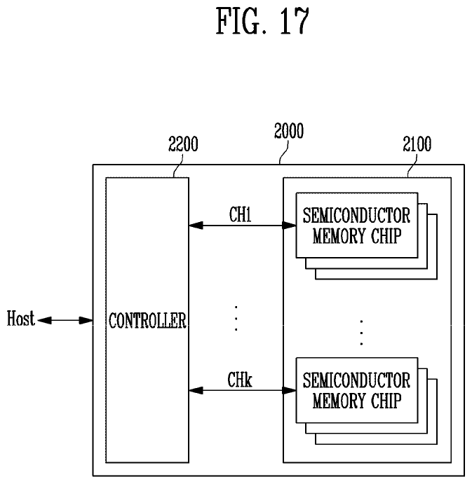

FIG. 17 is a block diagram illustrating an application example 2000 of the storage device of FIG. 16.

Referring to FIG. 17, the storage device 2000 includes a semiconductor memory device 2100 and a controller 2200. The semiconductor memory device 2100 includes a plurality of semiconductor memory chips. The plurality of semiconductor memory chips are divided into a plurality of groups.

In FIG. 17, the plurality of groups communicate with the controller 2200 through first to k-th channels CH1 to CHk, respectively. Each semiconductor memory chip is configured and is operated similarly to one of the semiconductor memory device 1300 described with reference to FIG. 16.

Each group is configured to communicate with the controller 2200 through one common channel. The controller 2200 is configured similarly to the controller 1200 described with reference to FIG. 16 and is configured to control the plurality of memory chips of the semiconductor memory device 2100 through the plurality of channels CH1 to CHk.

In FIG. 17, a plurality of semiconductor memory chips are connected to each channel. However, it will be understood that the storage device 2000 may be modified so that one semiconductor memory chip is connected to each channel.

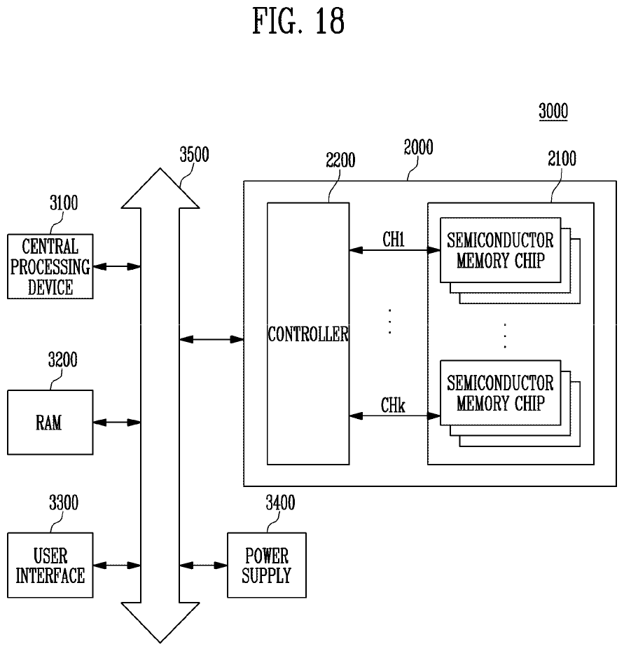

FIG. 18 is a block diagram illustrating a computing system including the storage device described with reference to FIG. 17.

Referring to FIG. 18, the computing system 3000 includes a central processing device 3100, a random access memory (RAM) 3200, a user interface 3300, a power supply 3400, a system bus 3500, and the storage device 2000.

The storage device 2000 is electrically connected to the central processing device 3100, the RAM 3200, the user interface 3300, and the power supply 3400 through the system bus 3500. Data provided through the user interface 3300 or processed by the central processing device 3100 is stored in the storage device 2000.

In FIG. 18, the semiconductor memory chip 2100 is connected to the system bus 3500 through the controller 2200. However, the semiconductor memory chip 2100 may be configured to be directly connected to the system bus 3500. In such a configuration, a function of the controller 2200 is performed by the central processing device 3100 and the RAM 3200.

In FIG. 18, the storage device 2000 described with reference to FIG. 17 is provided. However, the storage device 2000 may be replaced with the storage device 1000 described with reference to FIG. 16. In an embodiment, the computing system 3000 may be configured to include both of the storage devices 1000 and 2000 described with reference to FIGS. 16 and 17.

Although the present disclosure has been described with reference to the limited embodiments and drawings, the present disclosure is not limited to the embodiments described above, and various changes and modifications may be made from the disclosed description by those skilled in the art to which the present disclosure pertains.

Therefore, the scope of the present disclosure should not be limited to the described embodiments, and should be determined by the equivalents of the claims as well as the following claims.

In the embodiments described above, all of the steps may optionally be performed or omitted. In addition, the steps in each embodiment need not occur in order, and may be reversed. Meanwhile, the embodiments of the present disclosure disclosed in the present specification and the drawings are merely specific examples for easily describing the technical content of the present specification and facilitating understanding of the present specification and do not limit the scope of the present specification. That is, it is apparent to those skilled in the art to which the present disclosure pertains that other modification examples based on the technical spirit of the present disclosure are possible.

What is claimed is:

1. A method of operating a host device for controlling a trim operation for a storage device, the method comprising:
selecting a logical block address, the logical block address corresponding to data to be deleted;
transmitting a trim request corresponding to the selected logical block address to the storage device;
determining whether a re-transmission requirement of the trim request is satisfied; and
re-transmitting the trim request to the storage device in response to determining that the re-transmission requirement of the trim request is satisfied.

2. The method of claim 1, further comprising:
determining whether a trim operation completion message corresponding to the trim request has been received from the storage device.

3. The method of claim 2, further comprising:
determining that the re-transmission requirement of the trim request is satisfied in response to determining that the trim operation completion message corresponding to the trim request has not been received from the storage device.

4. The method of claim 2, further comprising:
determining that the re-transmission requirement of the trim request is satisfied in response to determining that the trim operation completion message corresponding to the trim request has not been received from the storage device and that a predetermined waiting time has elapsed.

5. The method of claim 2, wherein the re-transmission requirement of the trim request includes a requirement related to whether a time elapsed from when the trim request corresponding to the selected logical block address was transmitted to the storage device is greater than a threshold time.

6. A method of operating a host device for controlling a trim operation for a storage device, the method comprising:
selecting a logical block address corresponding to data to be deleted;
transmitting a first trim request corresponding to the selected logical block address to the storage device;
determining whether a re-transmission requirement of the first trim request is satisfied; and
transmitting a second trim request corresponding to the selected logical block address to the storage device in response to determining that the re-transmission requirement of the first trim request is satisfied.

7. The method of claim 6, wherein the first trim request indicates that the storage device is allowed to delay performance of a corresponding trim operation to a later time.

8. The method of claim 7, wherein the second trim request indicates that the storage device is to immediately perform a corresponding trim operation.

9. The method of claim 8, wherein the re-transmission requirement of the first trim request includes a requirement related to whether a time elapsed from when the first trim request was transmitted to the storage device is greater than a threshold time.

10. A method of operating a storage device for performing a trim operation in response to a trim request from a host device, the method comprising:
receiving the trim request from the host device;
determining whether the trim request is a first trim request; and
performing the trim operation corresponding to the received trim request according to a result of the determination.

11. The method of claim 10, wherein performing the trim operation corresponding to the received trim request according to the result of the determination comprises:
storing the trim request in a buffer memory in response to determining that the trim request is the first trim request;
determining whether a process condition of the trim request is satisfied; and
performing the trim operation corresponding to the received trim request in response to determining that the process condition of the trim request is satisfied.

12. The method of claim 11, wherein performing the trim operation comprises:
reading map data corresponding to one or more trim requests stored in the buffer memory;
updating the map data based on the trim requests stored in the buffer memory; and
storing the updated map data.

13. The method of claim 10, wherein performing the trim operation corresponding to the received trim request according to the result of the determination comprises:
in response to determining that the trim request is the second trim request:
storing the trim request in a buffer memory;
reading map data corresponding to one or more trim requests stored in the buffer memory, the one or more trim requests including the trim request;
updating the map data, based on the one or more trim requests stored in the buffer memory; and
storing the updated map data.
